(19) United States
(12) Patent Application Publication
(10) Pub. No.: US 2025/0180798 A1
(43) Pub. Date: Jun. 5, 2025

(54) LIGHT PANEL WITH GRADIENT COLOR

(71) Applicant: KORRUS, INC., Los Angeles, CA (US)

(72) Inventors: Paul Kenneth Pickard, Los Angeles, CA (US); Benjamin Harrison, Los Angeles, CA (US); Robert Fletcher, Los Angeles, CA (US)

(21) Appl. No.: 19/049,630

(22) Filed: Feb. 10, 2025

Related U.S. Application Data
(63) Continuation of application No. PCT/US23/29773, filed on Aug. 8, 2023.
(60) Provisional application No. 63/396,028, filed on Aug. 8, 2022.

(51) Int. Cl. F21V 8/00

(52) U.S. Cl. CPC G02B 6/0058

(57) ABSTRACT

A light panel comprising a waveguide having an emission surface for emitting emitted light, and multiple light sources having at least first and second colors, said multiple light sources being optically coupled to said waveguide to create a color gradient between said first and second colors across said emission surface.

### REFERENCE TO RELATED APPLICATION

This application claims the benefit of U.S. Provisional Patent Application 63/396,028, filed Aug. 8, 2022, the entire disclosure of which is hereby incorporated herein by reference.

### FIELD OF INVENTION

The present invention is directed generally to a light panel, and, more specifically, to light panel with gradient color for biological and psychological impact.

### BACKGROUND

There is a substantial shortage of homes (single family and otherwise) in many parts of the country, leading to ever-increasing rents and upward pressure on existing home values. Converting newly vacant office space to living accommodations can help offset that shortfall. Specifically, with a greater proportion of professionals working from home, an expected trend over the coming years is the conversion of commercial office space to lofts, condos and apartments. However, many commercial buildings are not constructed in a fashion that allows for ample natural light for interior spaces. As such, there is a need for lighting appliances that can provide for the biological needs of occupants that would otherwise be achieved with natural light through windows. Such lighting appliances would provide adequate vertical Melanopic Lux primarily during the day. Even in multifamily dwelling with windows in every room, certain geographies with tendencies for consistent overcast skies could also benefit from such appliances.

In addition to providing the appropriate amount of light and the appropriate spectra, these appliances also have the potential to provide psychological cues to the occupants as to time of day and beauty to improve interior aesthetics and improve occupant ease and wellness.

Luminous panels akin to those used in ceiling lighting fixtures have been repurposed for vertical mounting with the trappings of a window to provide visual cues to the intended function of such panels. Unfortunately, these panels look nothing like windows, but rather glowing light fixtures set into the wall because of their stark white uniform appearance. Accordingly, Applicant recognizes the need for a luminous or light panel that more realistically mimics natural sunlight through a window. The present invention fulfills this need, among others.

### SUMMARY OF INVENTION

The following presents a simplified summary of the invention in order to provide a basic understanding of some aspects of the invention. This summary is not an extensive overview of the invention. It is not intended to identify key/critical elements of the invention or to delineate the scope of the invention. Its sole purpose is to present some concepts of the invention in a simplified form as a prelude to the more detailed description that is presented later.

Applicant discovered a surprisingly effective and simple approach for emulating natural sunlight through a window by introducing gradient color in light panels to provide a more pleasing aesthetic and a more convincing “artificial window” than can be provided by a uniform luminous panel.

Accordingly, in one embodiment, the present invention relates to a panel light comprising: (a) a waveguide having an emission surface for emitting emitted light; and (b) multiple light sources having at least first and second colors, said multiple light sources being optically coupled to said waveguide to create a color gradient between said first and second colors across said emission surface.

In a more particular embodiment, the panel light comprises (a) a planar waveguide having a top, a bottom, and an emission surface for emitting emitted light; (b) at least two light sources, a first light source configured to emit a first light and being optically coupled to the top of the planar light guide, and a second light source configured to emit a second light and being optically coupled to the bottom of the planar light guide; and wherein the emission light comprises the first light at the top and the second light at the bottom with a light gradient between the first and second light.

In another embodiment, the present invention relates to the use of a panel light comprising (a) a planar light guide having a top, a bottom, and an emission surface for emitting emitted light (b) at least two light sources, a first light source configured to emit a first light and being optically coupled to the top of the planar light guide, and a second light source configured to emit a second light and being optically coupled to the bottom of the planar light, the method comprising generating first and second light thereby resulting in the emitted light, wherein the emitted light is the first light at the top and the second light at the bottom with a light gradient from the first light to second light from the top and the bottom.

### BRIEF DESCRIPTION OF FIGURES

The patent or application file contains at least one drawing executed in color. Copies of this patent or patent application publication with color drawing(s) will be provided by the Office upon request and payment of the necessary fee.

FIGS. 1A and 1B show front and side views of a schematic of one embodiment of the light panel of the present invention.

FIGS. 2A and 2B show different color modes of the light panel of the present invention.

FIGS. 3 and 4 show embodiments of the chromaticity regions of the first and second colors of the present invention.

### DETAILED DESCRIPTION

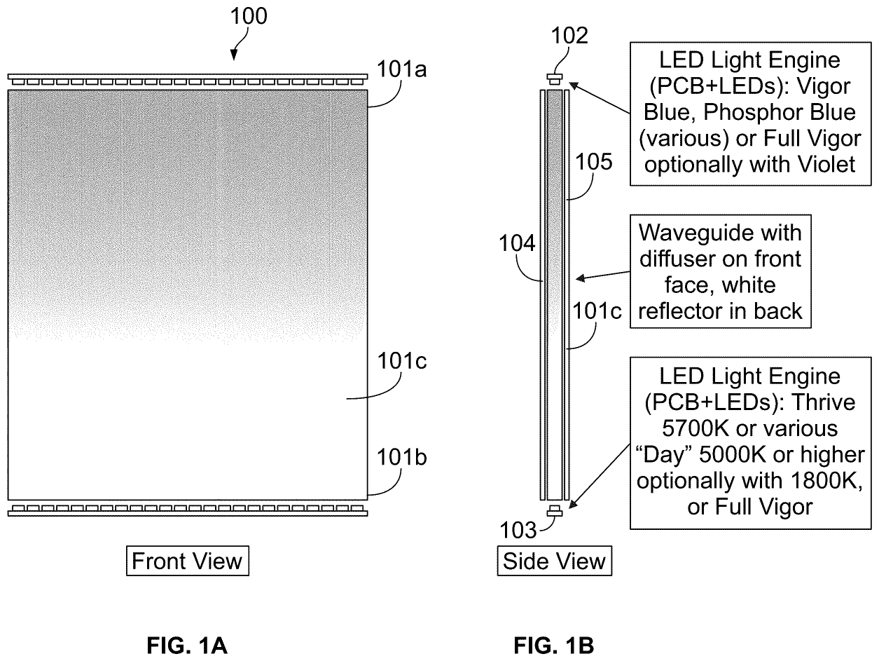

Referring to FIGS. 1A and B, one embodiment of the light panel 100 of the present invention is shown. In this embodiment, the light panel 100 comprises (a) a planar waveguide 101 having a top 101a, a bottom 101b, and an emission surface 101c for emitting emitted light, and (b) at least two light sources, a first light source 102 configured to emit a first light and being optically coupled to the top of the planar waveguide, and a second light source 103 configured to emit a second light and being optically coupled to the bottom of the planar waveguide. The emitted light is the first light at the top and the second light at the bottom with a light gradient from the first light to second light between the top and the bottom. Each of these features are described below in greater detail and with respect to selected embodiments.

The waveguide may comprise any known material for conducting light including, for example, glass and optically transparent polymeric materials. Additionally, the waveguide may comprise light extraction features which cause the light being conducted by the waveguide to be emitted from the waveguide through the emission surface. Such light extraction features are well known. In the embodiment of FIG. 1B, waveguide 101 also comprises a diffuser 105 on emission surface 101c, and a reflector 104 on the backside of the waveguide.

The waveguide may have any shape or configuration. For example, it may resemble a traditional window and be, for example, rectangular or square, or it may resemble a porthole and be, for example, round or oval. Other shapes include, for example, any polygon, stars, symbols, characters, etc. In one embodiment, the waveguide is planar, although it may be curved or even 3-dimensional (e.g., multifaceted, cylindrical, or spherical). Still other embodiments will be obvious to those of skill in the art in light of this disclosure.

Although the embodiment of FIG. 1A introduces light at the top and bottom of the waveguide, it should be understood that other embodiments are possible. For example, in one embodiment, light is introduced at the sides of the waveguide. (In this respect, it should be understood that top and bottom are relative terms, and that the light panel may simply be turned sideways such that the top and bottom of the waveguide become the sides.) In another embodiment, light is introduced along all edges of the waveguide (e.g., top, bottom, and sides). In yet another embodiment, light is introduced only along one edge and light converting materials, such as phosphors, or other light converting features are selectively disposed in the waveguide to convert the introduced light (e.g., blue light) to a different color (e.g., white light) to create a color gradient. Still other embodiments will be obvious to those of skill in the art in light of this disclosure.

Although the embodiment shown in FIG. 1A is configured to operate as a single unit, other embodiments in which two or more units operate as modules in a system are possible. For example, in one embodiment, the panels are synchronized to pass the color gradient from one to the next to make a big continuous gradient. In another embodiment, multiple panels are synchronized to show the same effect across all the panels Still other embodiments will be obvious to those of skill in the art in light of this disclosure.

### Color Modes

The first and second light sources along with a waveguide are configured to create a gradient of light across the waveguide that emulates natural sunlight through a window. Several different color systems can be used to accomplish these effects, some of which will have greater impacts on the Circadian system than others. In one embodiment, the first light source and the second light source are configured in at least a first mode, wherein the first light is pale blue at a first intensity, and the second light is cool white to emulate natural sunlight during the day. In one embodiment, the first light source and the second light source are configured in at least a first mode and a second mode to emulate light during different times of the day. In one embodiment, the first light source and the second light source are configured in a second mode, wherein the first light is pale blue at a second intensity or violet/blue, and the second light is orange/amber to emulate light during dawn and sunset. In one embodiment, the first intensity is greater than the second intensity.

In one embodiment, the pale blue light is between 9000K to 30000K, the cool white light is between 3100K and 8000K, and the orange/amber light is between 1500 to 3000K. In a more particular embodiment, the pale blue light is between 5000K to 12000K, the cool white light is between 3100K and 4500K, and the orange/amber light is between 1500 to 3000K.

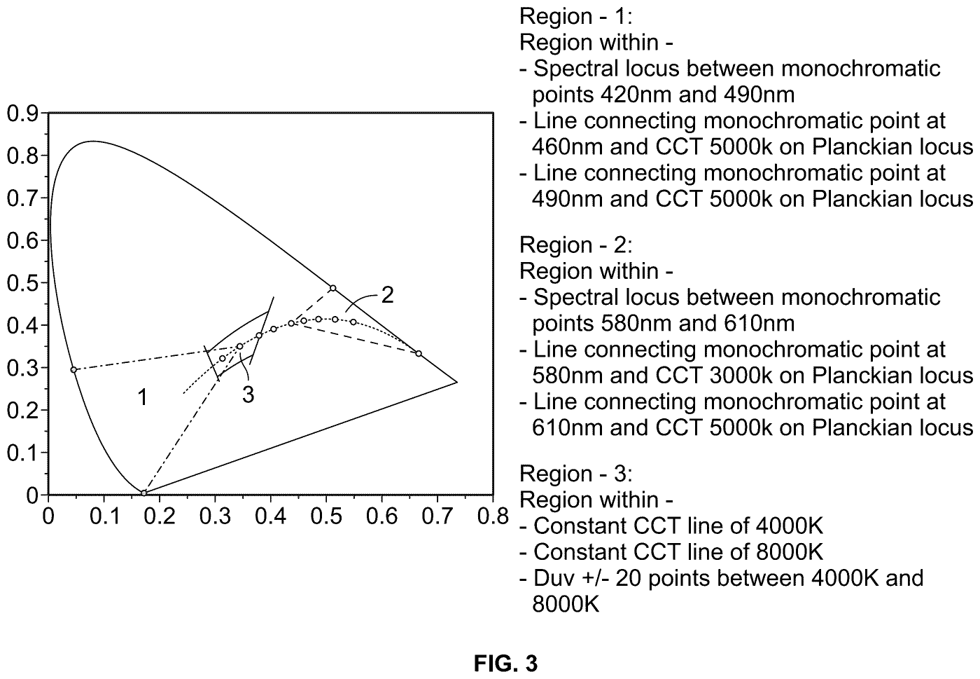

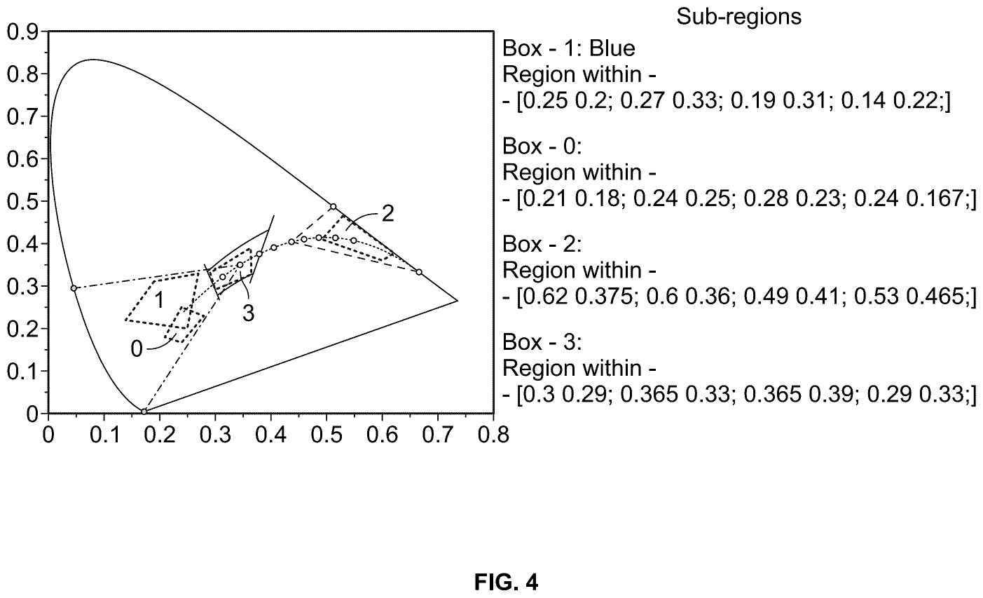

In one embodiment, pale blue and violet/blue are defined as within Region 1 in FIG. 3, which is defined as the region within the spectral locus between monochromatic points 420 nm and 490 nm, the line connecting monochromatic point at 460 nm and CCT 5000K on Planckian locus, and the line connecting monochromatic point at 490 nm and CCT 5000K on Planckian locus. More particularly, in one embodiment, pale blue is defined as Box 1 in FIG. 4 and violet/blue is defined as Box 0 in FIG. 4. Box 1 is defined by coordinates (0.25 0.2; 0.27 0.33; 0.19 0.31; 0.14 0.22), and Box 0 is defined by coordinates (0.21 0.18; 0.24 0.25; 0.28 0.23; 0.24 0.167).

In one embodiment, cool white is defined as Region 3 in FIG. 3, which is defined as the region within the constant CCT line of 4000K, the constant CCT line of 8000K, and Duv+/−20 points between 4000K and 8000K. More particularly, in one embodiment, cool white is defined by Box 3 in FIG. 4, which has the coordinates (0.3 0.29; 0.365 0.33; 0.365 0.39; 0.29 0.33).

In one embodiment, orange/amber is defined as Region 2 in FIG. 3, which is within the region defined by the constant CCT line of 4000K, the constant CCT line of 8000K, and Duv+/−20 points between 4000K and 8000K. More particularly, in one embodiment, orange/amber is defined in Box 2 in FIG. 4, which has the coordinates (0.62 0.375; 0.6 0.36; 0.49 0.41; 0.53 0.465).

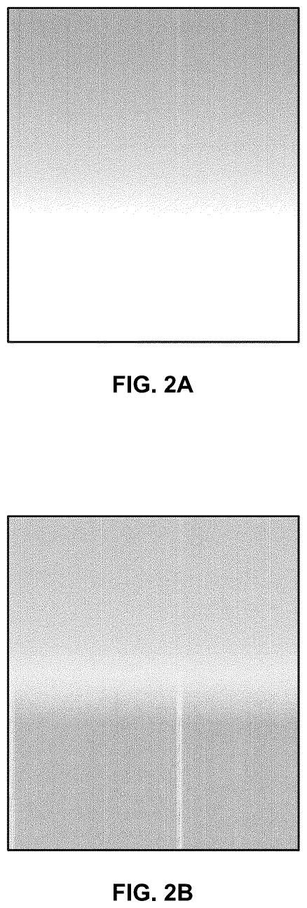

In one embodiment, the light modes represent different times of the day. For example, in one embodiment, the first mode may be configured to represent midday, while the second mode may be configured to represent dawn or dusk. For example, referring to FIGS. 2(A) and 2(B), an embodiment is shown having different color gradient modes.

Generally, different colored light engines are used to pump the waveguide from the top and bottom of the panel. In FIG. 2(A) (a daytime view) a pale blue is injected from the top edge, while a full-spectrum cool white light is injected from the bottom edge. This configuration provides a view like a translucent glass pane might when facing a sunny exterior scene with a clear view of the horizon.

In FIG. 2(B), a high color rendering 1800K source is used on the bottom edge and a pale blue source is injected from the top edge. In this instance, the blue intensity is reduced such that the hue appears to shift darker as would be expected at sunrise or sunset. In this configuration, a violet source could be used in combination with the pale blue source to provide a more convincing shift into the night sky. Additionally, in one embodiment, adding a violet component to the “morning sky” may align a user's circadian rhythm and make the user more receptive to high blue/high circadian stimulation later in the day.

In one embodiment, the color of the panel changes throughout the day to emulate the sky as it changes throughout the day. For example, in an embodiment in which midday is represented by a first mode, and dawn/dusk are represented by the second mode, the light panel can be configured to transition between the second mode in the morning to the first mode midday, and back to the second mode at dusk, before going dark. For example, in one particular embodiment, during the course of a day, the top light source transitions from violet/blue to pale blue to violet/blue and finally to off, and the bottom light source transitions from orange/amber to cool white to orange/amber and finally to off.

### Vertical Melanopic Lux

Although the circadian stimulation from the panels may vary, in one embodiment, the panel is configured to deliver the well building standard (see https://standard.wellcertified.com/light/circadian-lighting-design). For example, in one embodiment, the panel is configured to deliver at least 125, or at least 150, or at least 200, or at least 250 melanopic lux. Alternatively or in addition to, in one embodiment, the system delivers at least 20 microwatts/cm² corneal illuminance of blue light (i.e. 440-495 nm) during daytime, and below 2 microwatts/cm² corneal illuminance of blue light for nighttime based on a user being at a distance of 1 meter from the light emitting surface.

### Control

Approaches for driving the light sources can vary from simple to complex. For example, in a simple embodiment, the light panel has a single driver for driving the first and second light sources. For example, in a simple embodiment, just one driver is used along with a splitter for providing power to the first and second light sources. For example, in an on/off or dim-only configuration, both of these LED strings could be driven together or with some minor current dividing circuit in place to minimize the electronic complexity. In one embodiment, the at least one driver comprises simple dimming functionality to change the intensity of at least one of the first or second light sources without changing color. In another embodiment, switching from first and second modes is done without transition and simply involves switching between different settings in the driver.

In more complex embodiments, multiple drivers are used to drive and transition the top and bottom light sources from the first mode to the second mode. The transition may vary. For example, in one embodiment, the transition involves incremental color changes. In another embodiment, the transition is continuous, without a discernible step change in color changes. For example, in one embodiment, the color of the top light source is configured to vary from pale blue to violet/blue, and the color of the bottom light source is configured to vary from cool white to orange/amber. In one embodiment, variation of light color is controlled by a dimmer or a timer synced to an astronomical clock. In one embodiment, the transition of the top and bottom light sources is controlled through a smart phone application, an on-fixture dimmer, a wall dimmer, or a timer synched to the date/time.

In more complex embodiments, at least two drivers are used such that the first and second light sources have dedicated drivers. In one embodiment, the at least one driver comprises a plurality of drivers configured to independently vary at least the color or the intensity of the top and bottom light sources.

Although FIG. 1A shows two light bars in which all the individual light sources (e.g., LEDs) operate in unison, other embodiments exist. For example, in one embodiment, the individual light sources are individually addressable allowing individual light sources to be driven individually to have different colors. Thus, rather than creating a color gradient by mixing the first and second colors in the waveguide as described above, a color gradient can be created along the light source by discretely controlling different light sources from the top to the bottom of the panel to emit incrementally different colors, resulting in a color gradient from top to bottom. Such an embodiment is more complex, but may be preferable to control the light gradient more precisely. Such an embodiment also may be preferred if the panel is illumined from the sides as described above.

### Light Sources

The light sources vary in configuration. For example, in one embodiment, the first and second light sources are light bars. Other embodiments may include, for example, discrete LEDs disposed on the top and bottom edges of the light guide. In one embodiment, the individual light sources are independently addressable as described above. Still other embodiments will be obvious by those of skill in the art in light of this disclosure.

The light sources for producing the first and second colors as described above are commercially available. In one embodiment, the top light source is selected from the group consisting of Vigor Blue, Nichia phosphor converted Cyan or equivalent, Lumileds phosphor converted Blue, Full Vigor system, and any of the above with additional violet light. Still other light options will be obvious to those of skill the art in light of the disclosure.

In one embodiment, the bottom light source is selected from the group consisting of the Full Vigor System, 5700K Bridgelux Thrive, 5000K Samsung “Day”, 5000K Lumileds “Day”, and any of the above +1800K high CRI white for sunrise/sunset modes. Still other light options will be obvious to those of skill the art in light of the disclosure.

### Mounting

The physical configuration of the light panel can vary according to application. In one embodiment, the light panel is a unitary component configured for hanging on a wall. Such embodiment, after hanging, then can be enhanced by window treatments or other features to emulate a window. Alternatively, in one embodiment, the light panel is integral to the wall. Again, in such an environment, the panel can be augmented with window treatments and other features to enhance its appearance as a window. Still other embodiments will be obvious to those of skill in the art in light of this disclosure.

These and other advantages maybe realized in accordance with the specific embodiments described as well as other variations. It is to be understood that the above description is intended to be illustrative, and not restrictive. Many other embodiments and modifications within the spirit and scope of the claims will be apparent to those of skill in the art upon reviewing the above description. The scope of the invention should, therefore, be determined with reference to the appended claims, along with the full scope of equivalents to which such claims are entitled.

What is claimed is:

1. A light panel comprising:
a waveguide having an emission surface for emitting emitted light; and
multiple light sources having at least first and second colors, said multiple light sources being optically coupled to said waveguide to create a color gradient between said first and second colors across said emission surface.

2. The light panel of claim 1, wherein
said waveguide is a planar light guide having a top and a bottom;
wherein said multiple light sources comprise at least two light sources, a first light source configured to emit said first light and being optically coupled to said top of said planar light guide, and a second light source configured to emit said second light and being optically coupled to said bottom of said planar light guide; and
wherein said emitted light is said first light at said top and said second light at said bottom with a light gradient from said first light to second light between said top and said bottom.

3. The light panel of claim 1, wherein said first light source and said second light source are configured in at least a first mode and a second mode.

4. The light panel of claim 1, wherein said first light source and said second light source are configured in at least a first mode, wherein said first light is pale blue at a first intensity, and said second light is cool white.

5. The light panel of claim 4, wherein said first light source and said second light source are configured in a second mode, wherein said first light is pale blue at a second intensity or violet/blue, and said second light is orange/amber.

6. The light panel of claim 5, wherein said first intensity is higher than said second intensity.

7. The light panel of claim 5, wherein pale blue is 9000K to 30000K, wherein said cool white is between 3100K and 8000K, and wherein orange/amber is 1500 to 3000K.

8. The light panel of claim 7, wherein pale blue is 5000K to 12000K, wherein said cool white is between 3100K and 4500K, and wherein orange/amber is 1500 to 3000K.

9. The light panel of claim 3, wherein at least one driver for driving said first and second light sources.

10. The light panel of claim 9, wherein at least one driver configured to transition said top and bottom light sources from said first mode to said second mode.

11. The light panel of claim 10, wherein said transition is through incremental color changes.

12. The light panel of claim 10, wherein said transition is continuous.

13. The light panel of claim 10, wherein the color of the top light source is configured to vary from pale blue to violet/blue, and the color of said bottom light source is configured to vary from cool white to orange/amber.

14. The light panel of claim 13, wherein variation of light color is controlled by a dimmer or a timer synced to an astronomical clock.

15. The light panel of claim 13, wherein during the course of a day, the top light source transitions from violet/blue to pale blue to violet/blue and finally to off, and said bottom light source transitions from orange/amber to cool white to orange/amber and finally to off.

16. The light panel of claim 15, wherein the transition of the top and bottom light sources is controlled through an application, an on-fixture dimmer, a wall dimmer, or a timer synched to the date/time.

17. The light panel of claim 9, wherein said at least one driver comprises a splitter for providing power to said first and second light sources.

18. The light panel of claim 9, wherein said at least one driver comprises simple dimming functionality to change the intensity of at least one of the first or second light sources without changing color.

19. The light panel of claim 9, wherein said at least one driver comprises at least two drivers with said first and second light sources having a dedicated driver.

20. The light panel of claim 19, wherein said at least one driver comprises a plurality of drivers configured to independently vary at least the color or the intensity of the top and bottom light sources.

21. The light panel of claim 19, wherein said first and second light sources are light bars.

22. The light panel of claim 19, wherein said top light source is selected from the group consisting of Vigor Blue, Nichia phosphor converted Cyan or equivalent, Lumileds phosphor converted Blue, Full Vigor system, and any of the above with additional violet light.

23. The light panel of claim 19, wherein said bottom light source is selected from the group consisting of the Full Vigor System, 5700K Bridgelux Thrive, 5000K Samsung “Day”, 5000K Lumileds “Day”, and any of the above +1800K high CRI white for sunrise/sunset modes.
